(19) United States
(12) Patent Application Publication
(10) Pub. No.: US 2003/0035982 A1
(43) Pub. Date: Feb. 20, 2003

(54) Hybrid power device and method for manufacturing the same

(76) Inventors: Kwang-sun Ryu, Daejon (KR); Yong-joon Park, Daejon (KR); Soon-ho Chang, Daejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/107,520

(22) Filed: Mar. 26, 2002

(30) Foreign Application Priority Data
Aug. 14, 2001 (KR) 01-49024

(51) Int. Cl. H01M 14/00

(52) U.S. Cl. 429/7; 429/61; 429/188

(57) ABSTRACT

A hybrid power device having three electrodes and a method for fabricating the same are provided. The hybrid power device includes a lithium secondary battery and a supercapacitor in a cell and has three electrodes. The three electrodes have a common electrode including a positive electrode of the lithium secondary battery, which is as the positive electrode of the supercapacitor, a negative electrode of the lithium secondary battery including lithium metal and the other electrode of the supercapacitor. This hybrid power device is superior to that of a lithium secondary battery, and further is more economical and practical than a case where a lithium secondary battery and a supercapacitor are individually fabricated and used as a hybrid.

### BACKGROUND OF THE INVENTION

1. Field of the Invention

The present invention relates to a power device, and more particularly, to a hybrid power device including a lithium secondary battery and a supercapacitor in a cell, and a method of manufacturing the same.

2. Description of the Related Art

Today is a highly developed information-oriented society where individual information as well as commercial information has been highly valued. Therefore, reliable information communication systems are required. Also, electrical energy through which information communication systems are stably operated is absolutely needed. In this regard, solar energy generation and wind power generation have been introduced, and hybrid automobiles have been developed. Further, there is a need for excellent energy storage systems used in the effective information communication systems. As a result, a lot of interests have recently been concentrated on lithium secondary batteries and super capacitor as energy device systems capable of supplying stable and excellent energy resources.

However, conditions such as high-energy density, a long life, ultra slimness, lightweight, stability and ecological affinity, have been strongly required in compact secondary batteries. As compact secondary battery systems, Ni—Cd and lead acid batteries were developed at first, but they do not have the ecological affinity, and further, do not have high-energy density and output density required for high-performance electronic appliances. Accordingly, nowadays, Ni-MH or lithium-based secondary batteries have been on the rise as high energy density materials. The positive electrode used in a lithium secondary battery has different working electric potential and energy density according to a material for the lithium secondary battery. Thus, for the practical use and commercial production of the lithium secondary batteries, high capacity positive electrode materials must be developed or the characteristics of the existing positive electrode materials must be improved to make the most of the theoretical capacity thereof.

At present, layer compounds and three-dimensional compounds are used as positive electrode active material for lithium secondary batteries. For example, transition metal compounds such as lithium cobalt oxide (LiCoO₂) and lithium nickel oxide (LiNiO₂), which have layer structures, and lithium manganese oxide (LiMn₂O₄) having spinel structure, are mainly used as the positive electrode active materials. Meanwhile, a lot of attempts to use a polymer, such as an organic sulfide and a conducting polymer, as a positive electrode material are made. Also, researches into inorganic or organic hybrid electrodes have been under way.

A supercapacitor is referred to an ultracapacitor. Both the supercapacitor and the ultracapacitor can be called an electrochemistry capacitor that is a new-category energy storage device, being differentiated from the existing capacitors and secondary batteries. Such electrochemistry capacitors are divided into an electric double layer capacitor and a redox supercapacitor. The electric double layer is formed generally by non-faradic reaction causing no shift of electrons between an electrode and an ion. However, a capacitance of redox supercapacitor is generated by faradic reaction such as absorption reaction or redox reaction that causes the shift of electrons between an electrode and an ion. Such a capacitance is called a ‘pseudo-capacitance’. An inorganic metal oxide and a conducting polymer can be used as electrode materials for the redox supercapacitor using the pseudo-capacitance. The conducting polymer has merits in that it can be used as an electrode material both for a lithium secondary battery and the redox supercapacitor. Therefore, the conducting polymer is used as electrode material in lithium secondary battery and supercapacitor.

Meanwhile, a lithium secondary battery is not easy to be charged and discharged at high rate, whereas a supercapacitor can be charged and discharged at high rate, but cannot supply power for a long time. In this regard, there are a lot of researches into the development of a hybrid power device capable of adopting the above merits and supplementing the above defects. Mostly, the hybrid system is composed with battery and supercapacitor, battery and solar cell, or supercapacitor and solar cell. The connection methods for hybrid system is simple serial and parallel connection of two power systems or encapsulation with two power systems in a packing material. These hybrid systems have two electrode and outer circuit and independently manufactured systems. That is, a lithium secondary battery and a supercapacitor are individually fabricated and then electronic-circuit connected to be used as a power device.

### SUMMARY OF THE INVENTION

To solve the above problems, it is a first objective of the present invention to provide a hybrid power device having three electrodes: a shared positive electrode that is as the positive electrode of a lithium secondary battery and one electrode of a supercapacitor; and two negative electrodes that are connected with the lithium-metal negative electrode of the lithium secondary battery and the other electrode of the supercapacitor.

It is a second objective of the present invention to provide a method for fabricating a hybrid power device having three electrodes.

To achieve the first objective, there is provided a hybrid power device including a lithium secondary battery and a supercapacitor in a cell, and having three electrodes. The three electrodes include: a common (or shared) electrode including a positive electrode of the lithium secondary battery and one electrode of the supercapacitor, which is as the positive electrode or terminal of hybrid power device, a negative electrode of the lithium secondary battery including lithium metal, which is as the negative electrode or terminal of hybrid power device, and the other electrode of the supercapacitor, which is as the negative electrode or terminal of hybrid power device.

Preferably, the common electrode is formed of a conducting polymer electrode that can be used as the positive electrode of the lithium secondary battery and the electrodes of the supercapacitor. Also, preferably, an electrode active material for the conducting polymer electrode is a material selected from a group of consisting of polyaniline, polypyrrole, polythiopene, or their derivative.

Preferably, the same electrolyte solution that available both in the lithium secondary battery and the supercapacitor is used. Preferably, lithium salt for the electrolyte solution is a material selected from a group of LiPF₆, LiClO₄, LiBF₄, LiCF₃SO₃ or LiN(CF₃SO₂)₃, or a mixing solution of at least two materials selected from the group. Preferably, the solvent of the electrolyte solution is a material selected from a group of ethylene carbonate, diethyl carbonate, dimethyl carbonate, propylene carbonate, acetonitrile, diethoxyethane, dioxolane, tetrahydrouran, γ-butyrolactone or dimethylsulfoxide, or a mixing solution of at least two materials selected from the group.

Preferably, a porous separator or a polymer electrolyte is positioned between the positive and negative electrodes of the lithium secondary battery, and between both the electrodes of the supercapacitor. Preferably, the porous separator is formed of polyethylene, polypropylene, and their multilayers. Preferably, the polymer electrolyte is formed of a material selected from a group of poly(vinylenedene fluoride-co-hexafluoro propylene) (PVDF-HFP), polyacrylonitrile (PAN), or polymethylmethacrylate (PMMA).

The hybrid power device may further include a logic circuit that is switched properly according to the extent of energy required in an outer load. The common electrode is connected with the positive terminal of the logic circuit, and the negative electrode of the lithium secondary battery and one electrode of the supercapacitor are connected with the negative terminal of the logic circuit. To reduce the interference between the negative electrode of the lithium secondary battery and the one electrode of the supercapacitor, the logic circuit is adapted. The negative electrode of the lithium secondary battery to operate the lithium secondary battery for the supply of energy is connected with negative terminal of logic circuit when energy required by an outer side is small. The one electrode of the supercapacitor to operate the supercapacitor for the supply of energy is connected with negative terminal of logic circuit when energy required by an outer side is large.

To achieve the second objective, there is provided a method of fabricating a hybrid power device including the steps of: preparing a conducting polymer electrode, which is to be used as a common electrode, by coating the both sides of an electric charge collector with an electrode active material, and then, preparing a conducting polymer electrode, which is to be used as electrodes of the supercapacitor, by coating one side of another electric charge collector with an electrode active material; sequentially depositing a lithium metal electrode, a porous separator, a conducting polymer electrode, which is to be used a common electrode, a porous separator, and a conducting polymer electrode, which is to be used as electrodes of the supercapacitor; applying an electrolyte solution to the resultant; and packing the resultant by a material that is available for thermal vacuum packing.

Also, there is provided a method of fabricating a hybrid power device including the steps of: sequentially depositing a conducting polymer electrode in the shape of an electrode sheet, a polymer electrolyte, a conducting polymer electrode in the shape of an electrode sheet, which is a common electrode, and a polymer electrolyte; laminating the resultant at a predetermined time under a predetermined pressure to glue the materials of the resultant together; dipping the glued resultant into an electrolyte solution; depositing a piece of lithium metal on the resultant; and packing the resultant by a material that is available for thermal vacuum packing.

### BRIEF DESCRIPTION OF THE DRAWINGS

The above objective and advantages of the present invention will become more apparent by describing in detail a preferred embodiment thereof with reference to the attached drawings in which:

FIG. 1 is a schematic view of a hybrid power device including a lithium secondary battery and a supercapacitor in a cell;

FIG. 2 is a schematic view of a hybrid power system in which a logic device is connected with a hybrid power device including a lithium secondary battery and a supercapacitor in a cell;

FIGS. 3A and 3B are graphs showing the discharged capacity of a lithium secondary battery and of a supercapacitor, respectively;

FIGS. 4A and 4B are graphs showing a discharging curve of a lithium secondary battery that is composed of a lithium metal electrode and a conducting polymer electrode in the shape of powered mass, and a hybrid power device including a supercapacitor and a lithium secondary battery in a cell, which uses a conducting polymer electrode in the shape of powered mass as a common electrode; and

FIGS. 5A and 5B are graphs showing a discharging curve of a lithium secondary battery that is composed of a lithium metal electrode and a conducting polymer electrode in the shape of an electrode sheet, and a hybrid power device including a supercapacitor and a lithium secondary battery in a cell, which uses a conducting polymer electrode in the shape of electrode sheet as a common electrode.

### DETAILED DESCRIPTION OF THE INVENTION

The present invention will now been described more fully with reference to the accompanying drawings, in which a preferred embodiment of the invention is shown. This invention may, however, be embodied in many different forms and should not be construed as being limited to the embodiment set forth herein; rather, this embodiment is provided so that this disclosure will be thorough and complete, and will fully convey the concept of the invention to those skilled in the art. The reference numerals in different drawings represent the same elements, and thus their description will be omitted.

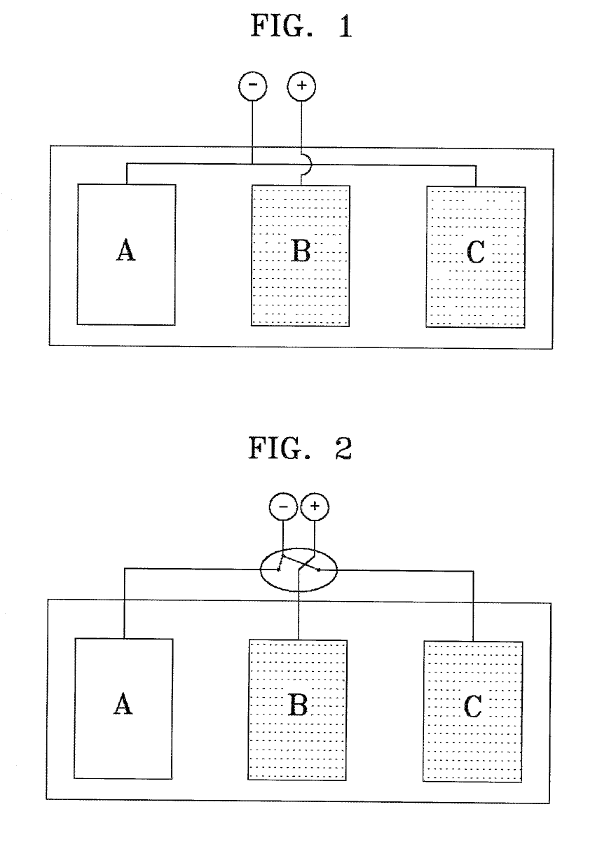

FIG. 1 is a schematic view of a hybrid power device including a lithium secondary battery and a supercapacitor in a cell. Referring to FIG. 1, the hybrid power device is a power device having three electrodes, in which the lithium secondary battery and the supercapacitor are put in the same electrolytic solution. Here, the lithium secondary battery uses a lithium (Li) metal material A as a negative electrode and a conducting polymer B as a positive electrode, and is divided by a porous separator or a polymer electrolyte, which is positioned between the Li metal material A and the conducting polymer B. The supercapacitor uses the positive electrode of the lithium secondary battery as one electrode B and a conducting polymer C as another electrode, and is divided by a porous separator or a polymer electrolyte, which is positioned between the one electrode B and the other electrode C. The conducting polymer B, which functions, as the positive electrode of the lithium secondary battery and the one electrode of the supercapacitor, is a common electrode as the positive electrode or terminal of hybrid power device. The lithium metal material A, which functions as the negative electrode of the lithium secondary battery, and the conducting polymer C, which functions as the other electrode of the supercapacitor, are connected with the negative electrode or terminal of hybrid power device.

When this hybrid power device, according to the present invention, is charged or discharged, the lithium metal material A and the common electrode become a negative electrode and a positive electrode in the lithium secondary battery, respectively. In the supercapacitor, the common electrode becomes an electrode and the other conducting polymer C becomes the other electrode. The supercapacitor operates for a short time during the high-rate discharge of the hybrid power device by an outer load, whereas the lithium secondary battery operates to supply energy during the low-rate discharge of the hybrid power device for a long time by an outer load. Due to such a discharge mode, a hybrid power device according to the present invention supplies energy more effectively than an energy supply device that is composed only of a lithium secondary battery. Further, the hybrid power device lasts for a long time.

To fabricate a hybrid power device according to a preferred embodiment of the present invention, material for a positive electrode, which is the common electrode, must be available both for a positive electrode of the lithium secondary battery and electrodes of the supercapacitor. Also, an electrolyte solution that is available both for the lithium secondary battery and the supercapacitor, must be used. To satisfy the above conditions, polyaniline, polypyrrole, polythiopene or their derivative can be used as an electrode active material for the common electrode. At least one lithium salt selected from lithium hexafluorophosphate (LiPF₆), lithium tetrafluoroborate (LiBF₄), lithium perclorate (LiClO₄), lithium trifluoromethansulfonate (LiCF₃SO₃) and lithium bistrifluoromethansulfonylamide (LiN(CF₃SO₂)₃), and at least one solvent selected from ethylene carbonate (EC), diethyl carbonate (DEC), dimethyl carbonate (DMC), propylene carbonate (PC), acetonitrile (AN), diethoxyethane, dioxolane, tetrahydrofuran (THF), γ-butyrolactone, and dimethylsulfoxide, are mixed to form an electrolyte solution. The lithium salt and solvent for the electrolyte solution can be used as a mixing material of at least two materials mentioned above. Polyethylene, polypropylene, or their multilayers can be used as a porous separator, and PVDF-HFP, PAN, and PMMA can be used as a polymer electrolyte.

FIG. 2 is a schematic view of a hybrid power system in which a logic device is connected with a power device having a cell in which a lithium secondary battery and a supercapacitor are installed. Referring to FIG. 2, the performance of the hybrid power system can be maximized by a logic circuit that is switched properly according to energy required in an outer load. At this time, a common electrode B is connected with the positive terminal of the logic circuit. The lithium metal electrode A is connected with the negative terminal of the logic circuit when the rate of energy required by an outer side is low, i.e., low-rate discharge, and thus, the lithium secondary battery operates to the supply of energy. On the other hand, when the rate of energy is high, i.e., high-rate discharge, the electrode C of the supercapacitor to operate the supercapacitor is connected with the negative terminal of the logic circuit. When the logic circuit is used like above, the interference between the lithium metal electrode A of the lithium secondary battery and the electrode C of the supercapacitor is reduced.

Hereinafter, method of fabricating a conducting polymer electrode, and a method of fabricating a hybrid power device including a lithium secondary battery and a supercapacitor in a cell will be described.

First, a method of fabricating a conducting polymer electrode will now be described. To make the conducting polymer electrode in the shape of a powered mass, active electric material such as polyaniline, polypyrrole, polythiopene or their derivative, a conducting material, and a binder are mixed in a container at the rate of 2:2:1. Then, a predetermined force is applied to press the mixed material in a container for about three hours, thereby forming the mixed material into a thin mass. The thin mass of electrode material is placed on an electric charge collector to be compressed by a press. As a result, the thin mass of electrode material is attached to the electric charge collector, which is used as an electrode.

To make a conducting polymer electrode in the shape of an electrode sheet, an electrode active material such as polyaniline, polypyrrole, polythiopene, or their derivative, and a conducting material are dispersed in acetone to form a muddy solution. Then, PVDF-based polymer is melted in acetone to form a binder. Next, the muddy solution and the binder are mixed, and agitated for about 24 hours to form a slurry solution. Thereafter, a gab device, which has predetermined intervals, is coated with the slurry solution to a predetermined thickness, and then, is dried at the room temperature for about one hour Then, the dried slurry solution is cut to a desired size, and then is deposited on an electric charge collector. Next, the deposited slurry is laminated at 100-130° C. under 40 kg/cm to be united with the electric charge collector.

Next, a method of fabricating a hybrid power device having a lithium secondary battery and a supercapacitor in a cell, will now be described. Such a hybrid power device can be made with conducting polymer electrode in the shape of a powered mass or conducting polymer electrode in the shape of an electrode sheet.

To make a hybrid power device with powdered polymer electrode, a sheet of filter paper or glass paper is placed on a protective stand such as teflon, and then, one or two drops of an electrolyte solution is applied thereto. Then, an electrode in which a piece of lithium metal is compressed to be attached to nickel mesh, is placed on the sheet of the filter paper or glass paper. Thereafter, a porous separator or a polymer electrolyte is deposited on the electrode, and then, two or three drops of the electrolyte solution are applied to the deposited porous separator or polymer electrolyte. Next, a conducting polymer electrode, which is formed of electrode active material, such as polyaniline, polypyrrole, polythiopene, or their derivative, is attached to the both sides of an electric charge collector, which is to be used as a common electrode on the resultant, and two or three drops of the electrolyte solution is applied to the conducting polymer electrode. Then, a porous separator or polymer electrolyte is deposited and two or three drops of the electrolyte solution are applied thereto. Next, a conducting polymer electrode, which is formed of an electrode active material attached to one side of the electric charge collector, is placed on the resultant. Then, a sheet of filter paper is placed on the conducting polymer electrode, and finally, a protective stand is placed on the sheet of the filter paper. Next, the resultant is packed by aluminum envelope that is available for thermal vacuum packing, and then, a hybrid power device having a lithium secondary battery and a supercapacitor in a cell, is completed.

A hybrid power device according to the present invention can be fabricated using a conducting polymer electrode in the shape of an electrode sheet. First, a conducting polymer electrode in the shape of an electrode sheet, a polymer electrolyte, a common electrode and a polymer electrolyte are sequentially deposited, and then are laminated at 100-130° C. under 40 kg/cm to glue all the materials together. The glued materials are dipped into an electrolyte solution for a predetermined time, and are taken out of the electrolyte solution. Then, a lithium metal electrode is deposited on the glued materials. The resultant is packed by aluminum envelope to form a hybrid power device having a lithium secondary battery and a supercapacitor in a cell.

Also, a hybrid power device according to the present invention may be fabricated with a porous separator. First, the both sides of an electric charge collector are coated with electrode active material to form a conducting polymer electrode as a common electrode. Then, one side of another electric charge collector is coated with electrode active material to form a conducting polymer electrode as the electrode of a supercapacitor. Thereafter, a lithium metal electrode, a porous separator, a conducting polymer electrode, which is to be used as a common electrode, a porous separator, and a conducting polymer electrode, which is to be used as the supercapacitor, are sequentially deposited. Next, an electrolyte solution is added to the resultant, and then is packed by aluminum envelope, thereby completing a hybrid power device having a lithium secondary battery and a supercapacitor in a cell.

### EXPERIMENTAL EXAMPLE 1

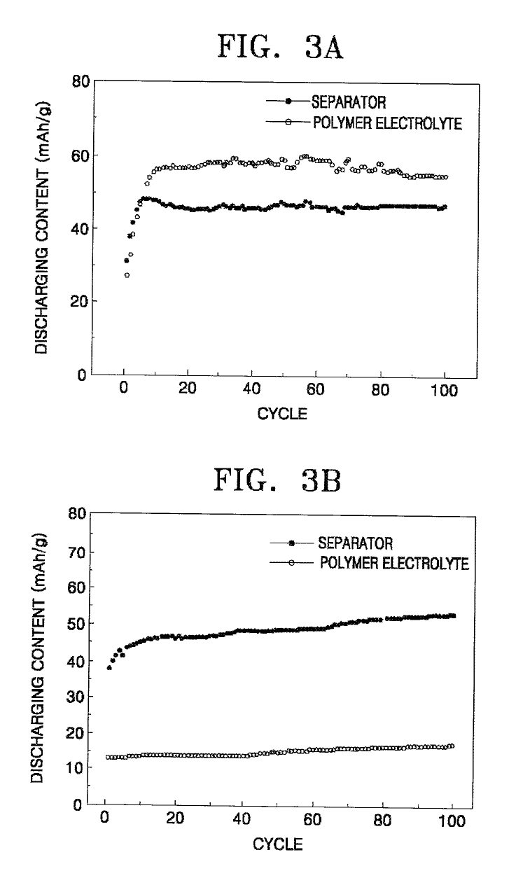

To test the performance of a hybrid power device according a preferred embodiment to the present invention, lithium secondary batteries were individually fabricated. First, with polyaniline as an electrode active material, two lithium secondary batteries were fabricated using an electrolyte solution mixed with 1 mol of LiPF₆, and a solvent of ethylene carbonate: dimethylcarbonate (1:1 V/V). Here, porous polypropylene/polyethylene/polypropylene film was used as a porous separator, and PVDF-HFP was used as a polymer electrolyte. Then, these lithium secondary batteries were charged at 0.025 mA/cm² and discharged at 0.125 mA/cm² and their performance was tested. The test result is as illustrated in FIG. 3A. From FIG. 3A, it is noted that one lithium secondary battery using a polymer electrolyte has a discharge capacity of about 55 mAh/g, an d the other lithium secondary battery using a porous separator has a discharge capacity of about 45 mAh/g. In the graph of FIG. 3A, the polymer electrolyte and the porous separator are indicated as ‘-∘-’ and ‘-●-’, respectively. In addition, the polyaniline doped with lithium salt as an electrode and the electrolyte solution used in this experimental is available in a lithium secondary battery.

### EXPERIMENTAL EXAMPLE 2

To test the performance of a hybrid power device according a preferred embodiment to the present invention, two symmetrical supercapacitors were individually fabricated. First, with polyaniline as an electrode active material, two supercapacitors were fabricated using an electrolyte solution mixed with 1 mol of LiPF₆, and a solvent of ethylene-carbonate: dimethylcarbonate (1:1 V/V). Here, porous polypropylene/polyethylene/polypropylene film was used as a porous separator, and PVDF-HFP was used as a polymer electrolyte. Then, these supercapacitors were charged at 0.025 mA/cm² and discharged at 2.5 mA/cm² and their performance was tested. The test result is as illustrated in FIG. 3B. From FIG. 3B, it is noted that a supercapacitor was discharged at 15 mAh/g if a polymer electrolyte is used, and was discharged at 45 mAh/g if the porous separator was used. In the graph of FIG. 3A, the polymer electrolyte and the porous separator are indicated as ‘-∘-’ and ‘-●-’, respectively. Nevertheless, the polyaniline doped with lithium salt as an electrode and the electrolyte solution used in this experimental is available in a supercapacitor.

### EXPERIMENTAL EXAMPLE 3

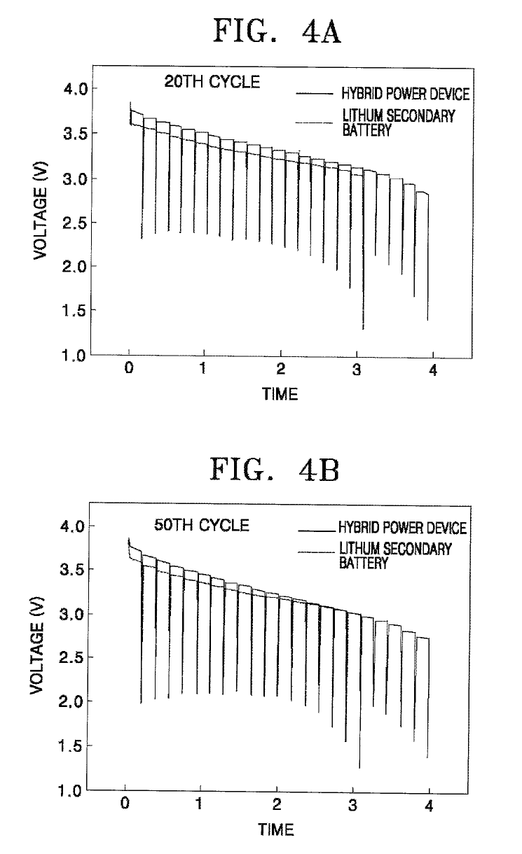

FIGS. 4A and 4B are graphs of discharging cycles of a lithium secondary battery including a lithium metal electrode and conducting polymer electrode in the shape of powered mass, and a hybrid power device, according to a preferred embodiment of the present invention, having a lithium secondary battery and an supercapacitor in a cell, which uses a conducting polymer electrode in the shape of powered mass as a common electrode. In FIGS. 4A and 4B, the lithium secondary battery and the hybrid power device are indicated as dotted lines and solid lines, respectively. The discharging cycles were measured when the lithium secondary battery and the hybrid power device were charged at 0.0625 mA/cm², discharged at the low rate of 0.0625 mA/cm² for ten minutes, and then discharged at the high rate of 2.5 mA/cm² for ten seconds. In detail, FIG. 4A and FIG. 4B show twentieth and fiftieth discharging cycles of the lithium secondary battery and the hybrid power device, respectively. From FIGS. 4A and 4B, it is noted that the hybrid power device has longer discharging time and reduced voltage drop than the lithium secondary battery on high rate discharging. Also, the voltage of the hybrid power device is the higher than or the same as that of the lithium secondary battery. Therefore, the performance of a hybrid power device according to the present invention seems to be superior to a lithium secondary battery.

### EXPERIMENTAL EXAMPLE 4

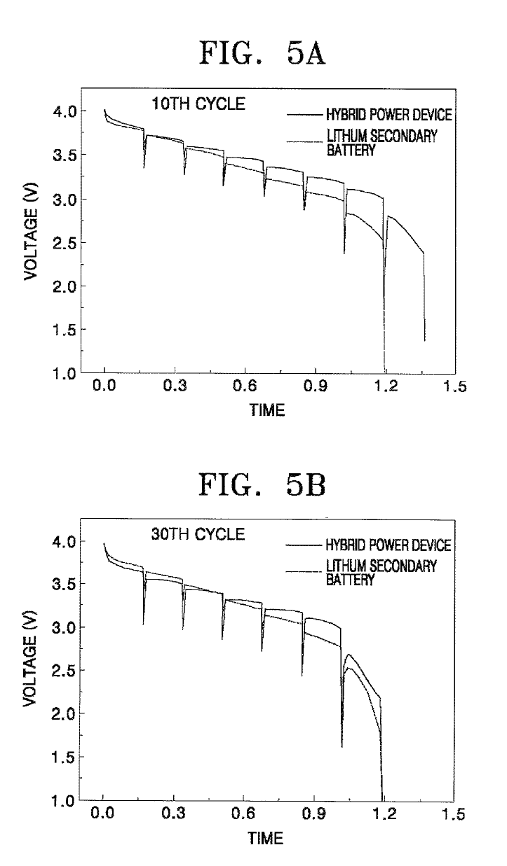

FIGS. 5A and 5B are graphs of discharging cycles of a lithium secondary battery including a lithium metal electrode and a conducting polymer electrode in the shape of an electrode sheet, and a hybrid power device, according to a preferred embodiment of the present invention, having a lithium secondary battery on an supercapacitor in a cell, which uses a conducting polymer common electrode in the shape of an electrode sheet as a common electrode. In FIGS. 5A and 5B, the lithium secondary battery and the hybrid power device are indicated as dotted lines and, a solid line, respectively. The discharging cycles were measured when the lithium secondary battery and the hybrid power device were charged at 0.025 mA/cm², discharged at the low rate of 0.125 mA/cm² for ten minutes, and then discharged at the high rate of 2.5 mA/cm² for ten seconds. In detail, FIG. 5A and FIG. 5B show tenth and thirtieth discharging cycles of the lithium secondary battery and the hybrid power device, respectively. From FIGS. 5A and 5B, it is noted that the hybrid power device has longer discharging time than the lithium secondary battery, and has high voltage recuperative power, thereby keeping high voltage even after the discharge at the high rate. Meanwhile, the rate of voltage drop of the hybrid power device is higher than that of the lithium secondary battery. However, the voltage of the hybrid power device is almost higher than that of the lithium secondary battery and the discharging time of the hybrid power device is longer than that of the lithium secondary battery, and thus, the performance of a hybrid power device according to the present invention seems to be superior to a lithium secondary battery.

As described above, the performance of a hybrid power device having a lithium secondary battery and a supercapacitor in a cell, according to a preferred embodiment of the present invention, is superior to that of a lithium secondary battery. Further, such a hybrid power device is more economical and practical than a case where a lithium secondary battery and a supercapacitor are individually fabricated and used as a hybrid. Such a hybrid power device is a new-generation power device that can be adapted to a power device for the mobile communication using a high output and a low output.

What is claimed is:

1. A hybrid power device including a lithium secondary battery and a supercapacitor in a cell, and having three electrodes,
wherein the three electrodes comprise:
a common electrode including a positive electrode of the lithium secondary battery, which is as the positive electrode of the supercapacitor;
a negative electrode of the lithium secondary battery including lithium metal and the other electrode of the supercapacitor.

2. The hybrid power device of claim 1, wherein the common electrode comprises a conducting polymer electrode that can be used as the positive electrode of the lithium secondary battery and the one electrode of the supercapacitor.

3. The hybrid power device of claim 2, wherein an electrode active material for the conducting polymer electrode is a material selected from a group of consisting of polyaniline, polyppyrrole, polythiopene, or their derivative.

4. The hybrid power device of claim 1, wherein the same electrolyte solution that available both in the lithium secondary battery and the supercapacitor is used.

5. The hybrid power device of claim 4, wherein lithium salt for the electrolyte solution is a material selected from a group of LiPF₆, LiClO₄, LiBF₄, LiCF₃SO₃ or LiN(CF₃SO₂)₃, or a mixing material of at least two materials selected from the group.

6. The hybrid power device of claim 4, wherein the solvent of the electrolyte solution is a material selected from a group of ethylene carbonate, diethyl carbonate, dimethyl carbonate, propylene carbonate, acetonitrile, diethoxyethane, dioxolane, tetrahydrouran, γ-butyrolactone or dimethylsulfoxide, or a mixing material of at least two materials selected from the group.

7. The hybrid power device of claim 1, wherein a porous separator or a polymer electrolyte is positioned between the positive and negative electrodes of the lithium secondary battery, and between both the electrodes of the supercapacitor.

8. The hybrid power device of claim 7, wherein the porous separator is formed of polyethylene, polypropylene, or their multilayers.

9. The hybrid power device of claim 7, wherein the polymer electrolyte is formed of a material selected from a group of poly(vinylenedene fluoride-co-hexafluoro propylene), polyacrylonitrile or polymethylmethacrylate.

10. The hybrid power device of claim 1, further comprising a logic circuit that is switched properly according to the extent of energy required in an outer load.

11. The hybrid power device of claim 10, wherein the common electrode is connected with the positive terminal of the logic circuit, and
the negative electrode of the lithium secondary battery and one electrode of the supercapacitor are independently connected with the negative terminal of the logic circuit, thereby reducing the interference between the negative electrode of the lithium secondary battery and the one electrode of the supercapacitor, and,
the logic circuit is connected with the negative electrode of the lithium secondary battery to operate the lithium secondary battery for the supply of energy when energy required by an outer side is small or connected with the one electrode of the supercapacitor to operate the supercapacitor for the supply of energy when energy required by an outer side is large.

12. A method of fabricating a hybrid power device comprising:
preparing a conducting polymer electrode, which is to be used as a common electrode, by coating the both sides of an electric charge collector with an electrode active material, and then, preparing a conducting polymer electrode, which is to be used as the other electrode of the supercapacitor, by coating one side of another electric charge collector with an electrode active material;
sequentially depositing a lithium metal electrode, a porous separator, a conducting polymer electrode, which is to be used a common electrode, a porous separator, and a conducting polymer electrode, which is to be used as electrodes of the supercapacitor;
applying an electrolyte solution to the resultant; and
packing the resultant by a material that is available for thermal vacuum packing.

13. A method of fabricating a hybrid power device comprising:
sequentially depositing a conducting polymer electrode in the shape of an electrode sheet, a polymer electrolyte, a conducting polymer electrode in the shape of an electrode sheet, which is a common electrode, and a polymer electrolyte;
laminating the resultant at a predetermined time under a predetermined pressure to glue the materials of the resultant together;
dipping the glued resultant into an electrolyte solution;
depositing a piece of lithium metal on the resultant; and
packing the resultant by a material that is available for thermal vacuum packing.
